(19) United States
(12) Patent Application Publication
(10) Pub. No.: US 2007/0067286 A1
(43) Pub. Date: Mar. 22, 2007

(54) Apparatus and method for organization and interpretation of multimedia data on a recording medium

(75) Inventors: Vladimir Portnykh, Croydon (GB); Deok-ho Kim, Seoul (KR); Du-il Kim, Suwon-si (KR); Young-yoon Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/415,096

(22) Filed: May 2, 2006

Related U.S. Application Data
(63) Continuation of application No. 10/559,374, filed on Dec. 6, 2005.
(60) Provisional application No. 60/489,936, filed on Jul. 25, 2003.

(30) Foreign Application Priority Data
Jun. 7, 2003 (KR) 10-2003-0036612

(51) Int. Cl. G06F 17/30; G06F 17/00

(52) U.S. Cl. 707/5; 707/104.1; 715/500.1; 715/730

(57) ABSTRACT

Disclosed is an apparatus for displaying multimedia data, to be described in the format of MusicPhotoVideo (MPV) format, wherein, when an asset selected by a user is comprised of a single audio data and at least one or more image data, the audio data is provided and at least one or more image data are subsequently displayed according to a predetermined method while the audio data is being displayed.

This is a divisional of application Ser. No. 10/559,374 filed Dec. 6, 2005. The entire disclosure of the prior application, application Ser. No. 10/559,374 is hereby incorporated by reference.

### TECHNICAL FIELD

The present invention relates to an apparatus and method for providing multimedia data, and a recording medium on which the method is recorded. More particularly, the present invention is directed to manage various kinds of multimedia data in the form of MusicPhotoVideo (hereinafter, referred to as ‘MPV’) format and to provide the multimedia data to users. MPV is an industry specification for multimedia titles, which was announced in November 2002 by the Optical Storage Technology Association (established by optical storage device manufacturers and hereinafter referred to as ‘OSTA’). MPV is a standard for more conveniently providing users with various kinds of music, photo and video content or allowing users to handle and process multimedia data. The definitions and other standards on MPV are available from the official OSTA web site.

### BACKGROUND ART

To execute a variety of existing audio, video and image files, application programs for the respective files are required. Even though there exist application programs for executing different formats of multimedia data files, they are applied to only the multimedia data files within a limited range. As a result, these application programs have a limitation in allowing users to execute multimedia data while maintaining their compatibility between various kinds of multimedia data.

On the other hand, MPV supports a function of managing various file associations using XML (Extensible Markup Language) metadata so as to reproduce various kinds of multimedia data recorded on a storage medium according to the intention of the users. In particular, MPV supports JPEG, MP3, WMA, WMV, MPEG-1, MPEG-2 and MPEG-4 as well as the digital camera formats of AVI and QuickTime MJPEG video. Further, an MPV standard disk is compatible with ISO9660 level 1, Joliet, multi-session CDs, DVDs, memory cards, hard disks and the Internet. Thus, MPV allows users to manage and process a wider variety of multimedia data. However, the specifications for MPV format require a greater number of elements for specifying formats of multimedia data that were not defined in the specifications (hereinafter, referred to as ‘asset’). Even in the method of providing various multimedia data to the users, it is required that various display functions for the multimedia data be added.

### DISCLOSURE OF INVENTION

Accordingly, the present invention is conceived to solve the problems in the related art. Accordingly, the present invention aims to allow MPV formats to be utilized in various manners by proposing multimedia elements for new multimedia data in addition to various kinds of multimedia elements currently proposed by the MPV formats and more variously providing users with multimedia data in an MPV format.

According to an aspect of the present invention for achieving the object, there is provided an apparatus for displaying multimedia data, to be described in a format of MusicPhotoVideo (MPV), wherein, when an asset selected by a user is comprised of a single audio data and at least one or more image data, the audio data is provided and at least one or more image data are subsequently displayed according to a predetermined method while the audio data is being provided. Preferably, the predetermined method comprises the step of displaying the image data according to time information indicating the time during which each piece of the image data is displayed while the audio data is being provided. Also preferably, the predetermined method further comprises the step of not displaying the image data when no time information exists.

According to another aspect of the present invention, there is provided a method for displaying multimedia data described in a format of MusicPhotoVideo (MPV), comprising the steps of (1) ascertaining whether an asset selected by a user is comprised of a single audio data and at least one or more image data, (2) extracting from the asset reference information for providing the audio data and the image data if the asset is comprised of a single audio data and at least one or more image data, (3) extracting and providing the audio data by use of the reference information, and (4) extracting at least one or more image data by use of the reference information and displaying them sequentially according to a predetermined method while the audio data is being provided. Preferably, the predetermined method comprises the step of displaying the image data according to time information indicating the time during which each piece of image data is displayed while the audio data is being provided. Also preferably, the predetermined method further comprises the step of not displaying the image data when no time information exists.

According to a further aspect of the present invention, there is provided a method for displaying multimedia data, to be described in a format of MPV, comprising the steps of ascertaining whether an asset selected by a user is comprised of a part of a single audio data, extracting from the asset reference information for providing the part of the single audio data if the asset is comprised of a part of a single audio data, and providing the part of the single audio data by use of the reference information according to a predetermined method. Preferably, the predetermined method uses location information on the provided part of the audio data, the location information comprising location information relative to time when the audio data is played. Also preferably, the location information on time comprises time information indicating a start time for playing the audio data, time information indicating the time during which the audio data is being played, time information indicating a stop time when playing of the audio data is terminated, or a combination of two or more of the time information.

According to a still further aspect of the present invention, there is provided a method for displaying multimedia data, to be described in a format of MPV, comprising the steps of ascertaining whether an asset selected by a user is comprised of a part of a single video data, extracting from the asset reference information for providing the part of the single video data if the asset is comprised of a part of a single video data, and displaying the part of the single video data by use of the reference information according to a predetermined method. Preferably, the predetermined method uses location information on a displayed part of the video data, the location information comprising location information relative time when the video data is played. Also preferably, the location information on time comprises time information indicating a start time for displaying the video data, time information indicating the time during which the video data is being displayed, time information indicating a stop time when displaying of the video data is terminated, or a combination of two or more of the time information.

According to another aspect of the present invention, there is provided a recording medium on which a program for displaying multimedia data to be described in a format of MPV is recorded, wherein the program ascertains whether an asset selected by a user is comprised of a single audio data and at least one or more image data, extracts reference information from the asset for providing the audio data and the image data where the asset selected by the user is comprised of a single audio data and at least one or more image data, extracts and displaying the audio data by use of the reference information, and allows at least one or more image data to be extracted by use of the reference information and then displayed sequentially according to a predetermined method while the audio data is being provided, the predetermined method comprising displaying the image data according to time information indicating the time that each piece of image data is displayed while the audio data is being provided.

According to a further aspect of the present invention, there is provided a recording medium on which a program for displaying multimedia data to be described in a format of MPV is recorded, wherein the program ascertains whether an asset selected by a user is comprised of a part of a single audio data, extracts reference information from the asset for providing the part of the audio data where the asset selected by the user is comprised of a part of the single audio data, provides the part of the audio data by use of the reference information according to a predetermined method, the predetermined method comprising displaying the provided part of the audio data by use of location information on the provided part of the audio data.

According to a still further aspect of the present invention, there is provided a recording medium on which a program for displaying multimedia data to be described in a format of MPV is recorded, wherein the program ascertains whether an asset selected by a user is comprised of a part of a single video data, extracts reference information from the asset for providing the part of the video data where the asset selected by the user is comprised of a part of the video data, displays the part of the video data by use of the reference information according to a predetermined method, the predetermined method comprising displaying the provided part of the video data by use of location information on the provided part of the video data.

### BRIEF DESCRIPTION OF DRAWINGS

The above and other objects, features and advantages of the present invention will be apparent from the following detailed description of the preferred embodiments of the invention in conjunction with the accompanying drawings, in which:

FIG. 1 is a block diagram illustrating the configuration of an apparatus for providing multimedia data according to the present invention;

FIG. 2 is a view illustrating the structure of an application program implemented by a method of providing multimedia data according to the present invention;

FIG. 3 is a view illustrating a state where multimedia data are displayed in accordance with user's function setting using the application program implemented by the method of providing multimedia data according to the present invention;

FIGS. 4 to 8 are views illustrating a variety of transitions according to the present invention;

FIG. 9 is a flowchart illustrating a method of providing multimedia data according to an embodiment of the present invention;

FIG. 10 is a flowchart illustrating processing steps from displaying a thumbnail grid to waiting for a user action according to an embodiment of the present invention; and<

FIG. 11 is a flowchart illustrating a process of executing a slideshow according to an embodiment of the present invention.

### BEST MODE FOR CARRYING OUT THE INVENTION

Hereinafter, an apparatus and method for providing multimedia data using an MPV format according to preferred embodiments of the present invention will be explained in detail with reference to the accompanying drawings.

In general, the present invention employs XML (Extensible Markup Language) to provide multimedia data in an MPV format, and will be hereinafter described in accordance with an XML-schema.

The present invention presents six new elements such as ‘AudioWithStill’, ‘AudioPart’, ‘VideoPart’, ‘AudioWithStilsRef’, ‘AudioPartRef’ and ‘VideoPartRef’, which are not defined by OSTA, so as to provide various multimedia data. The definitions and practices of usage for the six new elements will be discussed.

1. ‘AudioWithStill’ Element

The ‘AudioWithStill’ element is an element in which a single audio asset is grouped with one or more still assets. The still assets usually employ an image file of a screen resolution. The ‘AudioWithStill’ element can be defined in accordance with the XML-schema, as follows:

| | |
|---|---|
| (1) | element mpv:AudioWithStill, complexType mpv:AudioWithStillType |
| (2) | namespace http://samsung.co.kr/digitalmediaRd/avstation2 |
| (3) | type SMPV: AudioWithStillType |
| (4) | children |
| | mpv:ContentID, mpv:DocumentID, mpv:InstanceID, mpv:Metadata, |
| | nmf:Metadata, mpv:StillRefs, mpv:AudioRef, SMPV:DisplayTime, |
| | mpv:Related, mpv:Rendition |
| (5) | attributes |
| | Name Type Use Default Fixed |
| | mpv:id xs:ID |
| (6) | source <xs:element name=“AudioWithStill” type=“SMPV: AudioWithStillType” |
| | substitutionGroup=“mpv:CompositeAssetBase”/> |
| | source <xs:complexType name=“AudioWithStillType”> |
| | <xs:complexContent> |
| | <xs:extension base=“mpv:CompositeAssetBaseType”> |
| | <xs:sequence> |
| | <xs:element ref=“mpv:StillRef” maxOccurs=“unbounded”/> |
| | <xs:element ref=“mpv:AudioRef” /> |
| | <xs:element name=“ DisplaySchema ” type=“xs:string” minOccurs=“0”/> |
| | <xs:group ref=“mpv:RelationsElemGroup”/> |
| | </xs:sequence> |
| | </xs:extension> |
| | </xs:complexContent> |
| | </xs:complexType> |

The attribute value of the ‘DisplayTime’ element indicates the duration of the each still asset, in seconds. The attribute value of ‘DisplayTime’ always includes a relative time, which can be represented as a decimal point. If the attribute value of ‘DisplayTime’ is unspecified, the assumption is that there is no display duration. The definitions for the ‘DisplayTime’ element can be summarized as follows.

DisplayTime = <clock-value> (“;”<clock-value>)*
clock-value = (<seconds> | <unknown-dur>)
unknown-dur = the empty string
seconds = <decimal number> (“.”<decimal number>)?
decimal-number = [0-9] [0-9]*

The usage of the ‘DisplayTime’ element will be described. The attribute value of the ‘DisplayTime’ element of ‘3’ means that a still asset is displayed for 3 seconds, and the attribute value of the ‘DisplayTime’ element of ‘3;5’ means that a first still asset is displayed for 3 seconds and a second still asset is displayed for 5 seconds. Meanwhile, if the attribute value of the ‘DisplayTime’ element of ‘3.5;6;2.7’ means that first to third still assets are displayed for 3.5 seconds, 6 seconds and 2.7 seconds, respectively.

2. ‘AudioPart’ Element

An ‘AudioPart’ element specifies a part of an audio asset. The ‘AudioPart’ element can be defined in accordance with the XML-schema, as follows:

| (1) | namespace http://samsung.co.kr/digitalmediaRd/avstation2 | | | | |
|---|---|---|---|---|---|
| (2) | typeSMPV: AssetPartBaseType | | | | |
| (3) | children | | | | |
| | mpv:Metadata, nmf:Metadata, SMPV:start, SMPV:stop, | | | | |
| | SMPV:dur, mpv:AudioRef | | | | |
| (4) | attributes | | | | |
| | Name | Type | Use | Default | Fixed |
| | manifestLinkIDRef | xs:NCName | optional | | |
| | listIDRef | xs:NCName | optional | | |
| | mpv:id | xs:ID | | | |
| | idRef | xs:NCName | required | | |

<xs:complexType name=“AudioPart ”>
<xs:complexContent>
<xs:sequence>
<xs:element ref=“mpv:Metadata” minOccurs=“0”/>
<xs:element ref=“nmf:Metadata” minOccurs=“0”/>
<xs:element ref=“SMPV:start” minOccurs=“0”/>
<xs:element ref=“SMPV:stop” minOccurs=“0”/>
<xs:element ref=“SMPV:dur ” minOccurs=“0”/>
<xs:element ref=“mpv:AudioRef” minOccurs=“1”/>
</xs:sequence>
</xs:complexContent>
</xs:complexType>

The ‘manifestLinkIDRef’ specifying an attribute of the ‘AudioPart’ element provides a value of the ID (mpv:id) of a ‘ManifestLink’ asset containing a referenced asset. When no ‘manifestLinkIDRef’ is present, a current manifest (‘manifest’ means ‘OSTA XML MANIFEST’) is used.

Meanwhile, the ‘listIDRef’ provides a value of the ID (mpv:id) of an ‘AssetList’ or ‘MarkList’ containing a referenced asset. When no ‘listIDRef’ is present, the ‘AssetList’ in the same manifest is used.

Further, the ‘idRef’ provides a value of the ID (mpv:id) of a referenced asset. When no ‘listIDRef’ is present, the ‘AssetList’ in the current manifest is used. When no ‘manifestLinkIDRef’ is present, the current manifest is used.

Furthermore, the ‘SMPV:start’, ‘SMPV:stop’ and ‘SMPV:dur’ are defined as lower elements of the ‘AudioPart’ element. At least one of the three lower elements must be assigned with its attribute value.

The ‘SMPV:start’ element can be defined as &lt;xs:element name=“SMPV:start” type=“xs:long” minOccurs=“0”/&gt;. This element identifies a start time in seconds related to the beginning of the referencing asset. When this attribute is unspecified, it is assumed that the start time can be calculated based on the attribute values of ‘SMPV:stop’ and ‘SMPV:dur’ as [SMPV: start]=[SMPV: stop]−[SMPV: dur]. In a case where the attribute value of ‘SMPV: stop’ or ‘SMPV: dur’ is unspecified, the attribute value of ‘SMPV: start’ is equal to 0.

The ‘SMPV:stop’ element can be defined as &lt;xs:element name=“SMPV:stop” type=“xs:long” minOccurs=“0”/&gt;. This element identifies a stop time in seconds related to the beginning of the referencing asset. When any value is un specified, it is assumed that the stop time can be calculated based on the attribute values of ‘SMPV: start’ and ‘SMPV: dur’ as [SMPV: stop]=[SMPV: start]+[SMPV: dur]. In a case where ‘SMPV: dur’ is unspecified while the attribute value of ‘SMPV: start’ is given, the attribute value of ‘SMPV: stop’ is equal to the duration of the referenced asset. On the other hand, in a case where ‘SMPV: start’ is unspecified while the attribute value of ‘SMPV: dur’ is given, the attribute value of ‘SMPV: stop’ is equal to a value of ‘SMPV: dur’.

The ‘SMPV:dur’ element can be defined as &lt;xs:element name=“SMPV:dur” type=“xs:long” minOccurs=“0”/&gt;. This element identifies the duration of the fragment related to the referenced audio asset. When the attribute value of ‘SMPV:dur’ is un specified, it is assumed that the duration can be calculated as [SMPV: dur]=[SMPV: stop]−[SMPV: start]. In a case where the attribute value of ‘SMPV: stop’ or ‘SMPV: dur’ is unspecified, the value of ‘SMPV: dur’ is not defined.

3. ‘VideoPart’ Element

The ‘VideoPart’ element specifies a part of a video asset. The ‘VideoPart’ element can be defined in accordance with the XML-schema, as follows:

| (1) | namespace http://samsung.co.kr/digitalmediaRd/avstation2 | | | | |
|---|---|---|---|---|---|
| (2) | type SMPV: AssetPartBaseType | | | | |
| (3) | children | | | | |
| | mpv:Metadata, nmf:Metadata, SMPV:start, SMPV:stop, | | | | |
| | SMPV:dur, mpv:VideoRef | | | | |
| (4) | attributes | | | | |
| | Name | Type | Use | Default | Fixed |
| | manifestLinkIDRef | xs:NCName | optional | | |
| | listIDRef | xs:NCName | optional | | |
| | mpv:id | xs:ID | | | |
| | idRef | xs:NCName | required | | |

xs:complexType name=“VideoPart ”>
<xs:complexContent>
<xs:sequence>
<xs:element ref=“mpv:Metadata” minOccurs=“0”/>
<xs:element ref=“nmf:Metadata” minOccurs=“0”/>
<xs:element ref=“SMPV:start” minOccurs=“0”/>
<xs:element ref=“SMPV:stop” minOccurs=“0”/>
<xs:element ref=“SMPV:dur ” minOccurs=“0”/>
<xs:element ref=“mpv:VideoRef” minOccurs=“1”/>
</xs:sequence>
</xs:complexContent>
</xs:complexType>

4. ‘AudioWithStilsRef’ Element

The ‘AudioWithStilsRef’ element references the ‘AudioWithStill’ element. The ‘AudioWithStilsRef’ element can be defined in accordance with the XML-schema, as follows:

| (1) | Attributes | | | | |
|---|---|---|---|---|---|
| | Name | Type | Use | Default | Fixed |
| | manifestLinkIDRef | xs:NCName | optional | | |
| | listIDRef | xs:NCName | optional | | |
| | mpv:id | xs:ID | | | |
| | idRef | xs:NCName | required | | |

5. ‘AudioPartRef’ Element

The ‘AudioPartRef’ element references the ‘AudioPart’ element. The ‘AudioPartRef’ element can be defined in accordance with the XML-schema, as follows:

| (1) | Attributes | | | | |
|---|---|---|---|---|---|
| | Name | Type | Use | Default | Fixed |
| | manifestLinkIDRef | xs:NCName | optional | | |
| | listIDRef | xs:NCName | optional | | |
| | mpv:id | xs:ID | | | |
| | idRef | xs:NCName | required | | |

The ‘manifestLinkIDRef’ specifying the attribute of the ‘AudioPartRef’ element provides a value of the ID (mpv:id) of the ‘ManifestLink’ asset containing the referenced asset. When no ‘manifestLinkIDRef’ is present, a current manifest (the ‘manifest’ means ‘OSTA XML MANIFEST’) is used.

Meanwhile, the ‘listIDRef’ provides a value of the ID (mpv:id) of the ‘AssetList’ or ‘MarkList’ containing the referenced asset. When no ‘listIDRef’ is present, the ‘AssetList’ in the same manifest is used.

Further, the ‘idRef’ provides a value of the ID (mpv:id) of the referenced asset. When no ‘listIDRef’ is present, the ‘AssetList’ in the current manifest is used. When no ‘manifestLinkIDRef’ is present, the current ‘manifest ’ is used.

6. ‘VideoPartRef’ Element

The ‘VideoPartRef’ element references the ‘VideoPart’ element. The ‘VideoPartRef’ element can be defined in accordance with the XML-schema, as follows:

| (1) | Attributes | | | | |
|---|---|---|---|---|---|
| | Name | Type | Use | Default | Fixed |
| | manifestLinkIDRef | xs:NCName | optional | | |
| | listIDRef | xs:NCName | optional | | |
| | mpv:id | xs:ID | | | |
| | idRef | xs:NCName | required | | |

The method of providing the user with multimedia data using the new elements presented above can be expressed into XML, as follows. For the sake of convenience, the ‘AudioPart’ element of the six new elements will be taken as an example.

### EXAMPLE

01 - <mpv:Audio mpv:id=“D000100”>
02 - <mpv:LastURL>music.mp3</mpv:LastURL>
03 - </mpv:Audio>
04 - <SMPV:AudioPart mpv:id=“D0001001”>
05 - <mpv:AudioRef mpv:idRef=“D000100”/>
06 - <SMPV:start>2</SMPV:start>
07 - <SMPV:stop>7</SMPV:stop>
08 - </SMPV:AudioPart >
09 - <SMPV:AudioPart mpv:id=“D0001002”>
10 - <mpv:AudioRef mpv:idRef=“D000100/”>
11 - <SMPV:start>2</SMPV:start>
12 - <SMPV:dur>5</SMPV:dur>
13 - </SMPV:AudioPart>
14 - <SMPV:AudioPart mpv:id=“D0001002”>
15 - <mpv:AudioRef mpv:idRef=“D000100”/>
16 - <SMPV:stop>7</SMPV:stop>
17 - <SMPV:dur>5</SMPV:dur>
18 - </SMPV:AudioPart>

In the example, ‘01’ to ‘03’ indicate that an ID of the ‘Audio’ asset proposed in the MPV format standards is set to ‘ID000100’ and an audio file corresponding to the actual ‘Audio’ asset is set to ‘music.mp3’.

Further, in the example, ‘04’ to ‘08’ indicate that the ID of the ‘AudioPart’ asset according to the present invention is set to ‘ID0001001’ and the referenced ‘Audio’ asset is set to ‘music.mp3’ corresponding to the ID ‘ID000100’. At this time, it indicates that the music is played from 2 to only 7 seconds after the start point thereof in the entire length where the ‘music.mp3’ is played.

Further, in the example, ‘09’ to ‘13’ indicate that the ID of the ‘AudioPart’ asset according to the present invention is set to ‘ID0001002’ and the referenced ‘Audio’ asset is set to ‘music.mp3’ corresponding to the ID ‘ID000100’. At this time, it indicates that the music is played for 5 seconds from 2 seconds after the start point thereof in the entire length where the ‘music.mp3’ is played.

Furthermore, in the example, ‘14’ to ‘18’ indicate that the ID of the ‘AudioPart’ asset according to the present invention is set to ‘ID0001002’ and the referenced ‘Audio’ asset is set to ‘music.mp3’ corresponding to the ID ‘ID000100’. At this time, it indicates that the music is stopped at a time of 7 seconds after the start point of the music but for 5 seconds before the stop of the music in the entire length where the ‘music.mp3’ is played, i.e. the music is played from 2 seconds to 7 seconds after the start of the music.

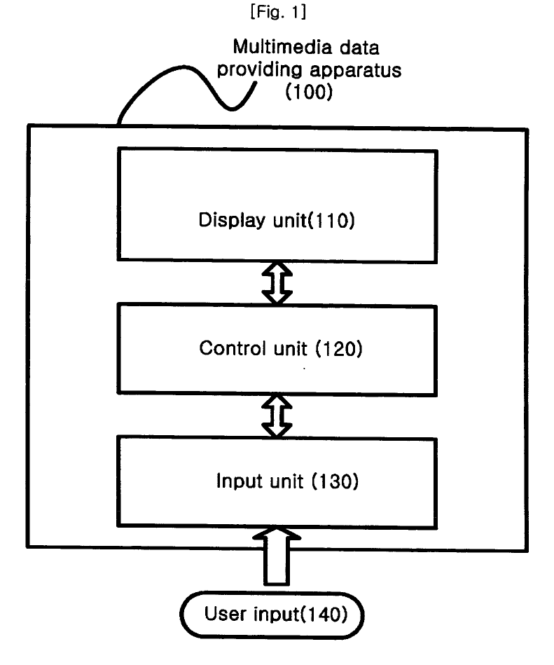

FIG. 1 is a block diagram illustrating the configuration of an apparatus 100 for providing multimedia data according to the present invention. The apparatus 100 of the present invention comprises a display unit 110 for selectively providing a first display mode in which only one multimedia data selected by a user is displayed among a plurality of multimedia data in the MPV format classified by the user, and a second display mode in which the plurality of classified multimedia data are sequentially displayed (hereinafter, referred to as ‘transitioned’); a user input unit 130 for selecting the display modes; and a control unit 120 for transferring, to the display unit, the display mode corresponding to control information input by the user input unit. At this time, a function of magnifying, reducing or rotating the displayed multimedia data, e.g. the image data, is provided when the first display mode has been selected by user input 140, while a function of sequentially transiting the plurality of multimedia data according to the data transition duration and the data display duration selected by the user is provided when the second display mode has been selected. Meanwhile, the multimedia data in the MPV format can be described in the form of an XML document, and be converted into a plurality of application documents depending on stylesheets applied to the XML document. According to the present invention, users can manage multimedia data through their browser by using the stylesheets for converting the XML documents into the HTML documents. Furthermore, the users can access multimedia data in MPV format through mobile terminals such PDAs, cellular phones, and smart phones by using the stylesheets for converting XML documents into WML and cHTML (compact HTML) documents.

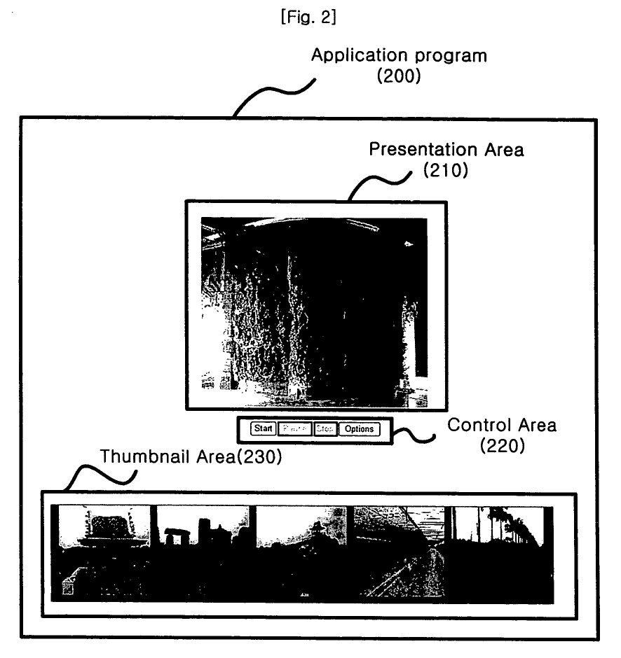

FIG. 2 is a view illustrating a preferred embodiment of an application program implemented by a method of providing multimedia data according to the present invention. Referring to FIG. 2, the application program 200 may include a presentation area 210, a control area 220 and a thumbnail area 230. In the thumbnail area 230, multimedia data previously classified by the user are provided. In the presentation area 210, multimedia data selected by the user in the thumbnail area are magnified and shown in the form of screen images, or multimedia data displayed in the thumbnail area are sequentially shown to the users in the form of slides. In the control area 220, the screen control of multimedia data displayed in the presentation area 210 is performed. For example, in a case where a plurality of image data are to be consecutively displayed, the display of image data is paused, the transition duration from one image data to next image data is set, or the display duration for one of the image data is set.

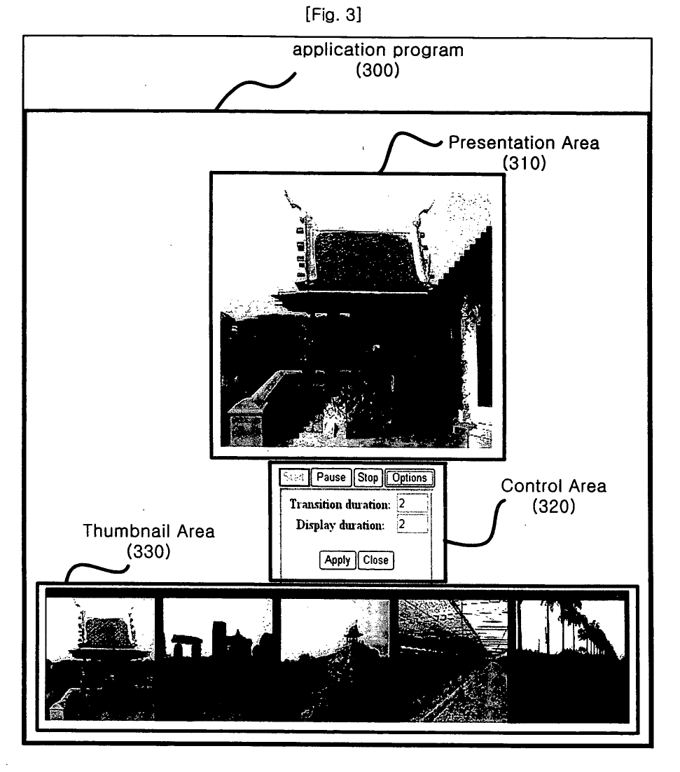

FIG. 3 is a view illustrating a state where a plurality of multimedia data are sequentially displayed in a presentation area 310 of an application program implemented by the method of providing multimedia data according to the present invention. A control area 320 is provided with a function of allowing the transition duration for the multimedia data and the display duration for one multimedia data to be set by the user input. Referring to FIG. 3, the transition duration is set to 2 seconds as ‘Transition duration’, and the display duration is set to 2 seconds as ‘Display duration’. Meanwhile, in the presentation area 310, it is shown that the sequential multimedia data are partially transited from the bottom right corner of the presentation area. This transition function is defined in SMPTE (Society of Motion Picture and Television Engineers). In the present invention, the transition function of transitioning the multimedia data in the MPV format using XML metadata is provided.

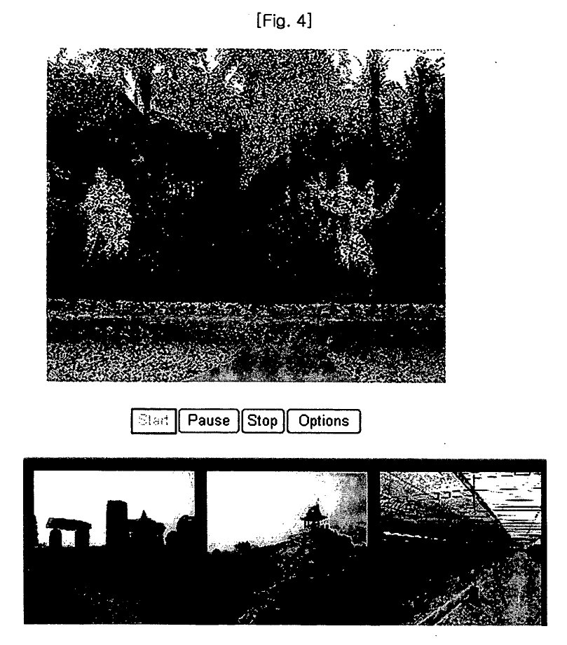

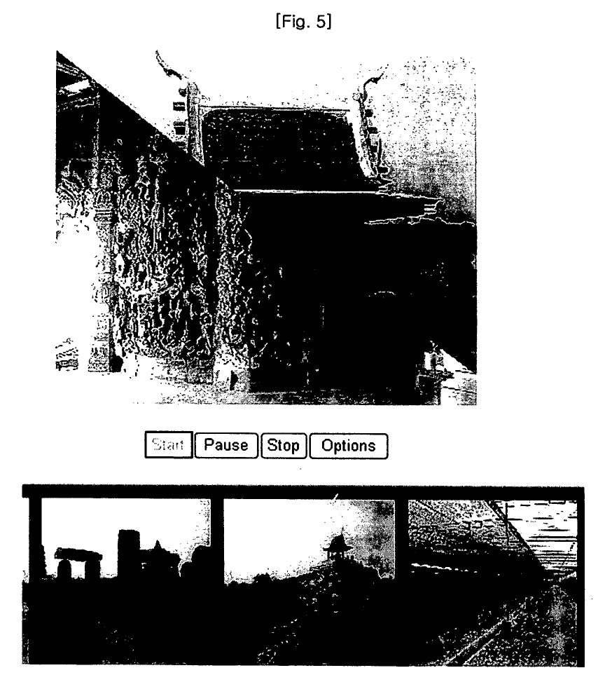

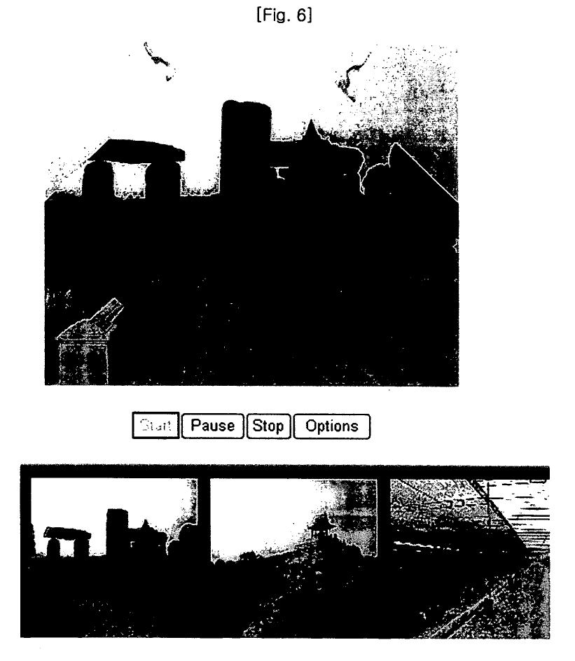

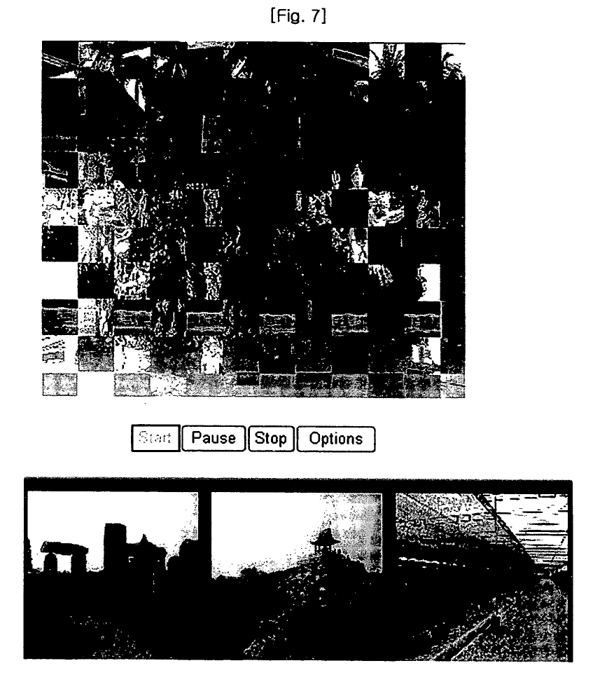

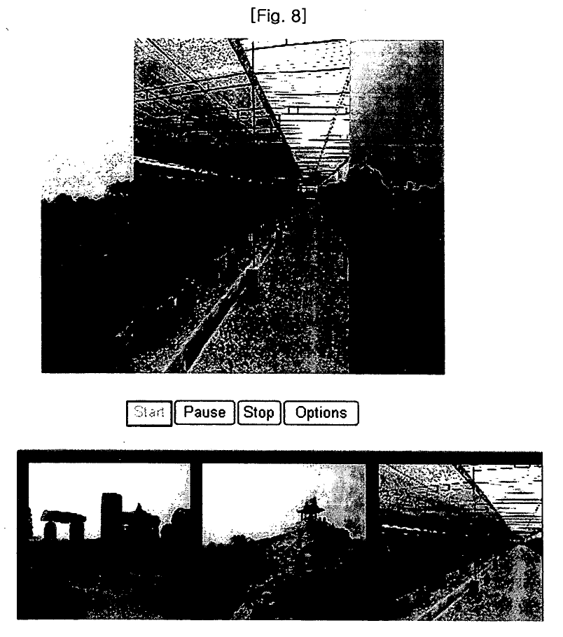

FIGS. 4 to 8 illustrate a variety of transition functions according to the present invention. FIG. 4 shows a state where the next multimedia data appear while the previous multimedia data fade, FIG. 5 shows a state where the next multimedia data appear from the top right corner of the presentation area 310, FIG. 6 shows a state where the next multimedia data appear outwardly from the center of the presentation area 310, FIG. 7 shows a state where the multimedia data are transitioned in the form of grids in the presentation area 310, and FIG. 8 shows a state where the next multimedia data appear horizontally from the center of the presentation area 310.

The algorithms for implementing the functions shown in FIGS. 2 to 8 according to the preferred embodiments of the present invention can be stepwise expressed as follows:

Step 1. Initialize the SMPV document

Step 2. Create the list of pointers to the asset objects

Step 3. Display the thumbnail grid

Step 4. Get the user action classified into Steps 5, 6 and 7

Step 5. Open an album

Step 6. Display screen rendition
Step 6.1. Display the “option”
Step 6.1.1. Zoom
Step 6.1.2. Rotate

Step 7. Start a slideshow
Step 7.1. Display slideshow controls
   Step 7.1.1. Pause slideshow
   Step 7.1.2. Stop slideshow
   Step 7.1.3. Display options
      Step 7.1.3.1. Change display duration/transition duration
      Step 7.1.3.2. Apply changes
      Step 7.1.3.3. Close options
Step 7.2. Run slideshow

Step 8. Display the next asset

Meanwhile, Tables 1 to 3 indicate function names for special classes used for implementing the algorithms, description on the functions, and steps in which respective functions are used.

TABLE 1
Class Name: Executer

| | | Step Where Function Is |
|---|---|---|
| Function Name | Description | Used |
| OpenDocument(strFileName) | Open mpv document | Step 1 |
| GetResourceList( ) | Create resource list | Step 2 |
| GetAlbum( ) | Return pointer to album | Step 3, Step5 |
| GetResourceList(Album) | Create resource list used in | Step 3, Step 5 |
| | album | |
| ExecuteSlideshow( ) | Execute slideshow | Step 7.1 |
| | | Step 7.1.3.2 |
| StartSlideshow( ) | Start slideshow | Step 7 |
| StopSlideshow( ) | Stop slideshow | Step 7.1.2 |
| Settings( ) | Display slideshow's settings | Step 7.1.3 |
| HideSettings( ) | Hide slideshow's settings | Step 7.1.3.3 |
| PauseSlideshow( ) | Pause slideshow | Step 7.1.1 |
| ChangeDurations( ) | Change transition/display | Step 7.1.3.1 |
| | durations | |
| ShowImage(srcpath, name) | Display asset | Step 6 |

TABLE 2
Class Name: Asset

| | | Step Where |
|---|---|---|
| | | Function Is |
| Function Name | Description | Used |
| Asset(type, refID, doc) | Initialize asset object | |
| GetThumbnailRenditionNTFS | Return path to thumbnail | Step 3 |
| LastURL | rendition | |
| GetScreenRenditionNTFSLast | Return path to thumbnail | Step 6 |
| URL | rendition | |
| NTFSLastURL | Return path to asset itself | Step 3 |
| ThumbnailRend | Return thumbnail rendition | Step 3 |
| ScreenRend | Return screen rendition | Step 6 |
| Rendition (value) | Return rendition | Step 3 |
| GetRefID | Return reference ID | Step 3 |
| GetClassName | Return asset class | Step 3 |

TABLE 3
Class Name: AssetRef

| | | Step Where |
|---|---|---|
| Function Name | Description | Function Is Used |
| AssetRef(node) | Initialize reference asset object | Step 2 |
| IsTransition | Return true if transition is | Step 7.2 |
| | defined | |
| TransitionType | Return transition type | Step 7.2 |
| TransitionSubType | Return transition subtype | Step 7.2 |
| TransitionDur | Return transition duration | Step 7.2 |
| TransitionIdx | Return transition index | Step 7.2 |

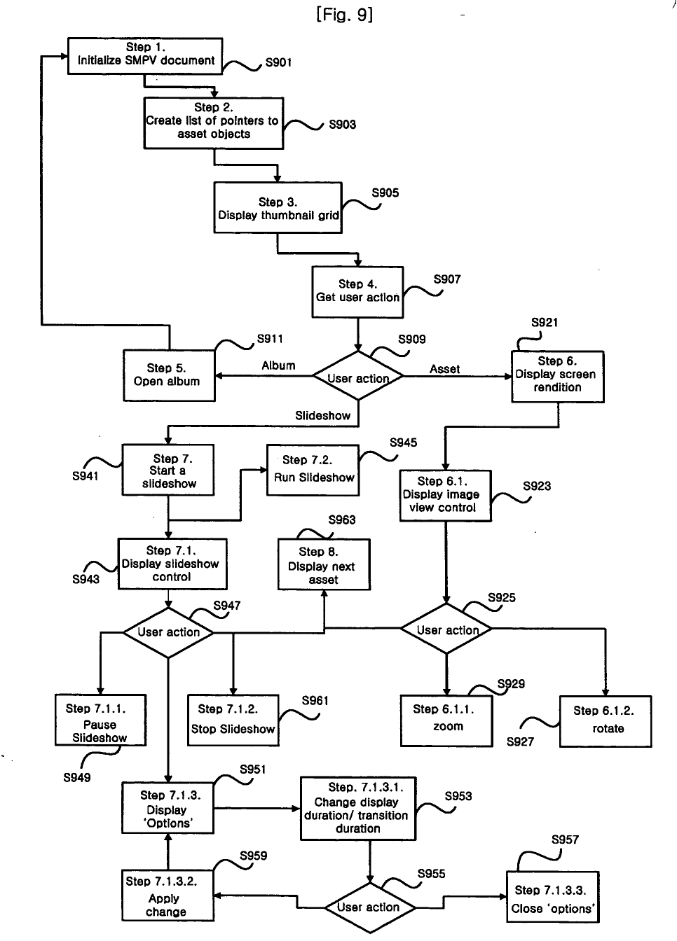

Meanwhile, FIG. 9 shows a flowchart illustrating the steps of implementing the method of providing multimedia data according to the present invention. The SMPV document in the MPV format that contains new elements of the present invention is first initialized (S901). The list of pointers to the asset objects is then created (S903). After the thumbnail gird is displayed (S909), the process waits for a user action (S907). If the user selects a new album, the new album is opened (S911), and then, the process returns to step S901 of initializing the SMPV document. If the user displays the screen rendition (S921), a function capable of controlling the screen rendition is provided (S923). Then, depending on the user's action, the zoom function may be performed (S929), the rotation function may be performed (S927) or the next asset may be displayed (S963). On the other hand, if the user selects a slideshow, the slideshow starts (S941). At this time, a function capable of controlling the slideshow is provided (S943) while the slideshow is executed (S945). Then, the user may pause the slideshow (S949) or stop the slideshow (S961). Alternatively, the user may select the ‘option’ menu (S951) to change the transition and display durations (S953) and to apply the changes thus made (S959). Therefore, the user can execute the slideshow in accordance with the changed transition and display durations.

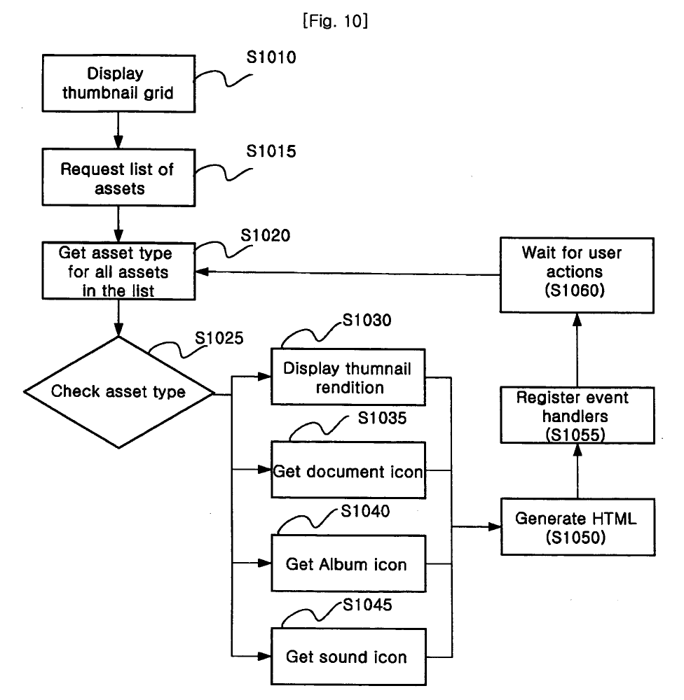

FIG. 10 is a flowchart specifically illustrating the process from displaying the thumbnail grid in step 3 to waiting for user actions in step 4 according to the present invention. After the thumbnail grid is displayed (S1010), the list of the assets is requested (S1015). Then, asset types for all the assets in the list are obtained (S1020), and they are checked (S1025). According to the asset types, the thumbnail rendition is displayed (S1030), a document icon is obtained (S1035), an album icon is obtained (S1040) or a sound icon is obtained (S1045). Thereafter, HTML is created (S1050) and the event handler is then registered (S1055). Then, the process waits for a user action (S1060) and the process returns to step S1020.

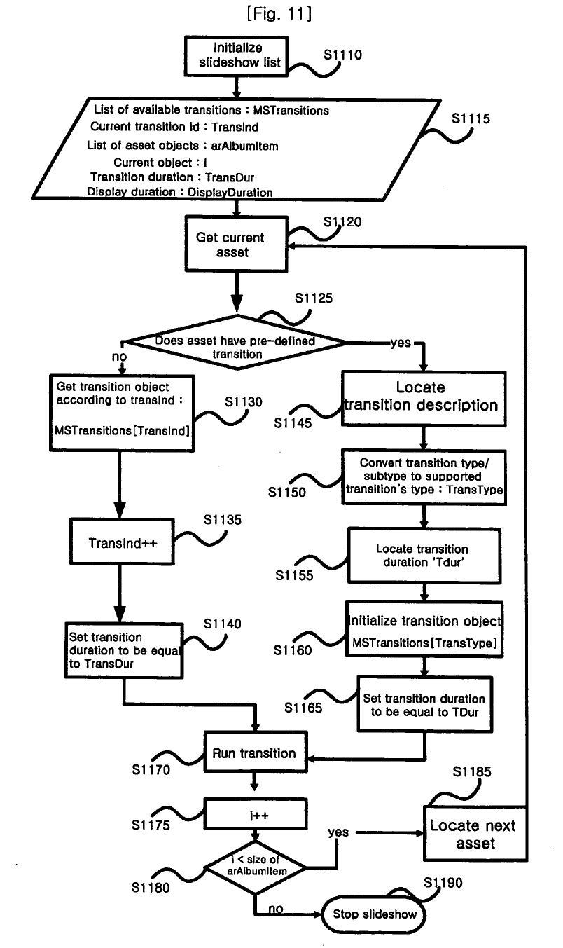

FIG. 11 is a flowchart specifically illustrating the process of executing the slideshow according to the present invention. Referring to FIG. 11, the assets in the album are sequentially provided to the user. At this time, each of the assets can be defined beforehand for the transition for specifying how the next assets appear. The slideshow list is first initialized (S110). Then, ‘MSTransitions’ indicating the list of available transitions, ‘TransInd’ indicating the current transition ID, ‘arAlbumItem’ indicating the list of the asset objects, ‘i’ indicating the index for the assets in the album, ‘TransDur’ indicating the transition duration, and ‘DisplayDuration’ indicating the display duration for one asset are set (S1115). Here, the data types of ‘MSTransitions’ and ‘arAlbumItem’ have the same structure as an array. After all parameters are set, the current asset is obtained (S1120). It is then checked whether the current asset has a predefined transition (S1125). If it is checked that the asset has no predefined transition, a transition object is obtained by using ‘TransInd’ as a parameter (S1130). To get the transition object for the next asset, the value of ‘TransInd’ is increased by 1 (S1135) and the transition duration is set to be equal to ‘TransDur’ (S1140). Thereafter, the transition is run (S1170). On the other hand, if it is checked in step (S1125) that the asset has a predefined transition, the predefined transition will have a higher priority than parameters such as ‘MSTransitions’, ‘TransInd’, ‘arAlbumItem’, ‘TransDur’ and ‘DisplayDuration’. Transition description is located from the database in which a variety of transition methods are stored (S1145), and the transition type or transition subtype is then converted into a supported transition type (S11150). The transition type so converted is defined as ‘TransType’. Further, the predefined transition may contain information on the transition duration, which in turn is used as ‘Tdur’ (S1155). After the transition object is initialized (S1160) and the transition duration is set to be equal to ‘TransDur’ (S1165), the transition is run (S1170). Then, the value of ‘i’ is increased (S1175). If the increased value of ‘i’ is smaller than the size of ‘arAlbumltem’, i.e. the number of the whole asset objects included in the album for providing the slideshow, the process will be moved or shifted to the next asset in the album and then returns to step S1120 (S1180 and S1185). If the value of ‘i’ is equal to or higher than the value of ‘arAlbumltem’, the slideshow is stopped (S11190).

### INDUSTRIAL APPLICABILITY

According to the present invention, a variety of multimedia data can be provided to the user and the user can manage and process the various multimedia data more efficiently by defining new concepts of multimedia data and providing the user with the multimedia data in various forms.

Although the present invention has been described in connection with the embodiments of the present invention shown in the accompanying drawings, it is not limited thereto. It will be apparent to those skilled in the art that various substitutions, modifications and changes may be made thereto without departing from the scope and spirit of the invention.

1. A method for displaying multimedia data, comprising the steps of:
(1) ascertaining whether an asset selected by a user is comprised of a single audio data and at least one or more image data;
(2) extracting from the asset reference information for providing the audio data and the image data if the asset is comprised of a single audio data and at least one or more image data;
(3) extracting and providing the audio data by use of the reference information; and
(4) extracting at least one or more image data by use of the reference information and displaying them sequentially according to a predetermined method while the audio data is being provided.

2. The method as claimed in claim 1, wherein the predetermined method comprises the step of displaying the image data according to time information indicating the time during which each piece of image data is displayed while the audio data is being provided.

3. The method as claimed in claim 2, wherein the predetermined method further comprises the step of not displaying the image data when no time information exists.

4. A recording medium on which a program for displaying multimedia data is recorded, wherein the program ascertains whether an asset selected by a user is comprised of a single audio data and at least one or more image data, extracts reference information from the asset for providing the audio data and the image data where the asset selected by the user is comprised of a single audio data and at least one or more image data, extracts and displaying the audio data by use of the reference information, and allows at least one or more image data to be extracted by use of the reference information and then displayed sequentially according to a predetermined method while the audio data is being provided, the predetermined method comprising displaying the image data according to time information indicating the time that each piece of image data is displayed while the audio data is being provided.
